(19) United States
(12) Patent Application Publication
(10) Pub. No.: US 2008/0154887 A1
(43) Pub. Date: Jun. 26, 2008

(54) METHOD AND SYSTEM FOR DISPLAYING INFORMATION

(75) Inventors: Shaun William Ryan, Christchurch (NZ); Wayne Alistair Munro, Christchurch (NZ); Jamie Glendinning Anstice, Christchurch (NZ); Geoffrey Michael Brash, Christchurch (NZ); Michael Arthur Grantham, Christchurch (NZ)

Correspondence Address: LOWE HAUPTMAN HAM & BERNER, LLP, 1700 DIAGONAL ROAD, SUITE 300, ALEXANDRIA, VA, 22314, US

(73) Assignee: S.L.I. Systems, Inc., Christchurch (NZ)

(21) Appl. No.: 11/946,675

(22) Filed: Nov. 28, 2007

(30) Foreign Application Priority Data
Dec. 1, 2006 (NZ) 551790

(51) Int. Cl. G06F 17/30

(52) U.S. Cl. 707/5; 707/E17.108

(57) ABSTRACT

A method (50) of providing an Internet search results list in response to an Internet keywords search request is disclosed. The method (50) starts by receiving (60) a list of keywords, a list of web pages associated with the keywords in the list of keywords, and quality factors associated with keyword-web page combinations. The quality factors are determined from user activities in response to a site specific search request. An Internet keywords search request is next received (62). A listing of web pages associated with keywords in the Internet keywords search request is then retrieved (64). The web pages in the listing are ranked (66) based upon associated quality factors to produce a ranked listing. Finally, the ranked listing is provided (68) in response to the Internet keywords search request. A method (10) is disclosed of recording an association between web pages of a web site and keywords. The method (10) stats by receiving (20) a site specific keyword search request by a site specific search facility associated with said web site. A listing of web pages of the web site is then provided (22). A selection of at least one web page from the listing of web pages is received (24) and a quality factor associated with keyword-web page combinations is determined (28). The quality factors is determined from user activities with the associated web page following said following the site specific keyword search request. Finally, the quality factors are recorded in association with respective keyword-web page combinations.

### TECHNICAL FIELD

The present invention relates to providing a ranked list of search results in response to a search request and, in particular, to providing a ranked list of search results where the ranking is determined through user interaction with web pages listed in the ranked list.

### BACKGROUND

Providers of Internet web sites generally wish to maximise the number of visitors to their sites. High volumes of traffic through a site can increase advertising revenue to the site operator, or alternatively boost the business operations of the site operator through advertising their goods and services.

The majority of traffic directed to web sites is generally sourced from search engines. Search engine web sites receive from a user a number of keywords, and then subsequently provide to the user a list of ranked web site addresses for web pages which contain content relevant to the keywords entered by the user. Search engines generally operate by running search “spiders”, or software agents which traverse URL (universal resource location) links displayed on web sites and return indications of the content of each page with its associated URL or address. These indicators are then used to determine a ranked association between keywords and URLs.

Web site content providers prefer to have their web site assigned a high association priority or rank as such results in the associated URL to be displayed high on the results listing when a search is conducted containing relevant keywords. The higher in the results listing the URL is displayed, the higher the probability of a user clicking through to the content provider's site and generating the traffic required.

The calculation of priority or page rank by search engines is commonly held as proprietary information by each search engine operator. However, in general terms web page rank (as calculated by the search engine Google™) can be promoted by increasing the number of links pointing to a particular web page.

Although web page rank does give an indication of potentially how popular the specific page is with respect to links provided by other web site authors, it is difficult for this technique to actually assess the quality or relevance of the content present in the web page. It is possible that a particular web page may have high quality content relevant to a keyword submitted by a searching user, but this user may be unlikely to find the particular web page involved due to a low priority being assigned in terms of page rank. In effect it is difficult for such pages which are not well known to be publicised by search engines irrespective of the quality of the content or information they contain.

It is also known for people or organisations to “spam” search engines. A search engine can be spammed through software code or agents submitting posts to an Internet blog or forum where these posts include a link to a web page which is to have its page rank improved. Such spams can be made in large numbers and are used to erroneously promote the relevance of the web page.

The rank assigned to web pages in search results is important both to the web site publisher and the searching user. Publishers would prefer to boost the traffic through their web site to in turn potentially increase sales in E-commerce applications. Searching users wish to access the most relevant web site results from their keyword searches. Although existing page rank or page prioritisation techniques will assist in these regards, it would be preferable to have an improved correlation between the quality or relevance of the content of the web page to the web page ranking in a search result page presented by the Internet search engine.

Users of search engines are also reliant on the information presented within a results listing to make a decision as to whether to click through this link to a particular web page. The results listing presented by the search engine generally consists of a couple of lines of text copied from the web site, which may not necessarily give the searching user a clear idea as to the content or relevance of the web page result or initial search query. The user is then forced to click through on a link and investigate the page directly to ascertain its relevance to their search.

It would therefore be preferable to have an improved method of formatting search engine results links with additional (potentially) more relevant information to assist in the review of such results by a user.

It is an object of the present invention to address the foregoing problems or at least to provide the public with a useful choice.

Further aspects and advantages of the present invention will become apparent from the ensuing description which is given by way of example only.

### SUMMARY OF THE INVENTION

According to an aspect of the present invention there is provided a method of providing an Internet search results list in response to an Internet keywords search request, said method comprising the steps of:
receiving a list of keywords, a list of web pages associated with the keywords in said list of keywords, and quality factors associated with keyword-web page combinations, said quality factors being determined from user activities in response to a site specific search request;
receiving said Internet keywords search request;
retrieving a listing of web pages associated with keywords in said Internet keywords search request;
ranking said web pages in said listing based upon associated quality factors to produce a ranked listing; and
providing said ranked listing in response to said Internet keywords search request.

According to another aspect of the present invention there is provided a method of recording an association between web pages of a web site and keywords, said method comprising the steps of:
receiving a site specific keyword search request by a site specific search facility associated with said web site;
providing a listing of web pages of said web site;
receiving a selection of at least one web page from said listing of web pages;
determining a quality factor associated with keyword-web page combinations, said quality factors being determined from user activities with the associated web page following said following said site specific keyword search request and
recording said quality factors in association with respective keyword-web page combinations.

According to yet another aspect of the present invention there is provided an apparatus for performing any one of the above-mentioned methods.

According to yet another aspect of the present invention there is provided a computer readable product having recorded thereon a program for implementing any one of the above-mentioned methods.

### BRIEF DESCRIPTION OF DRAWING

One or more embodiments of the present invention is now described with reference to the accompanying drawing in which:

FIG. 1 a schematic flow diagram of a method of recording an association between web pages of a web site and keywords used in a site specific keyword search;

FIG. 2 shows a schematic block diagram of a networked environment within which the method of FIG. 1 may be implemented; and

FIG. 3 shows a schematic flow diagram of a method performed in an aggregation service in order to provide an Internet search results list in response to an Internet keywords search request.

### DETAILED DESCRIPTION

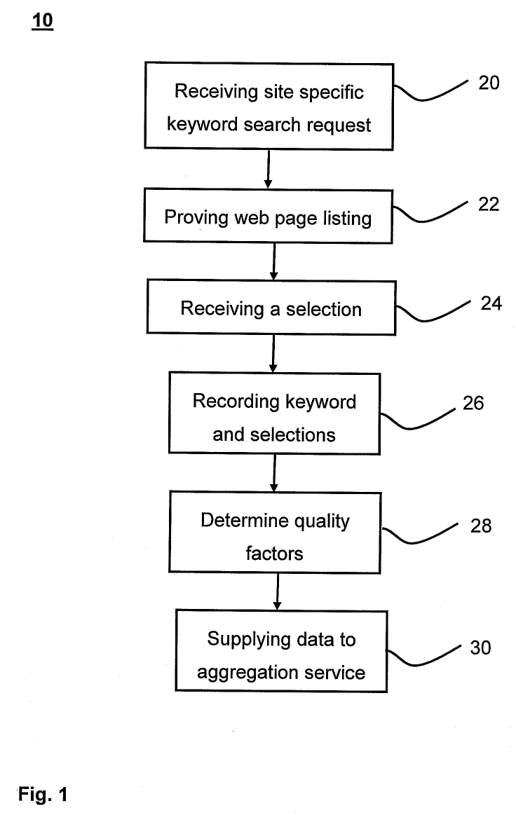

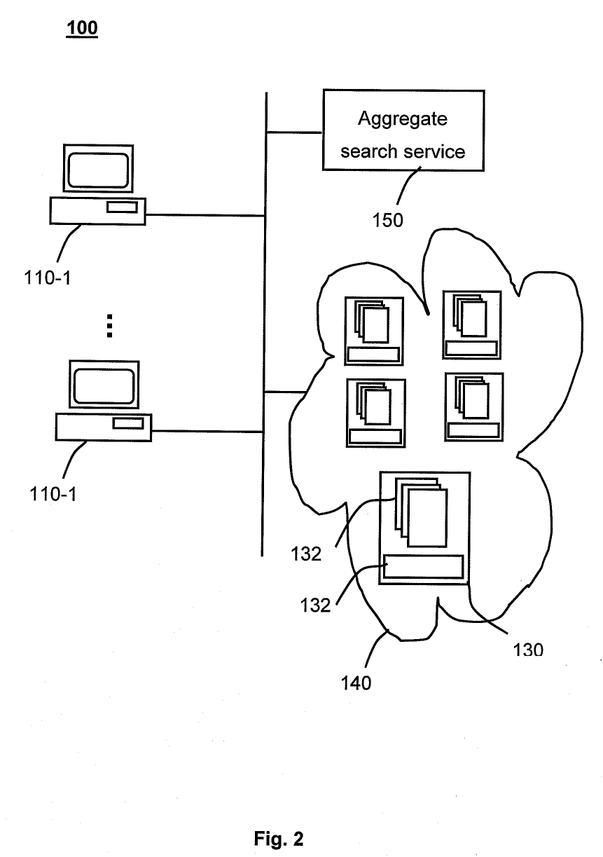

FIG. 1 shows a schematic flow diagram of a method 10 of recording an association between web pages of a web site and keywords used in a site specific keyword search. FIG. 2 shows a schematic block diagram of a networked environment 100 within which the method 10 may be implemented.

The networked environment 100 includes a network 105 for connecting one or more client computers 110, and a collection of web sites 130 available on servers (not shown) in the World Wide Web 140. The method 10 is implemented through software executing in the servers. The software may be stored on a computer readable medium. The software is read and executed in a processor (not illustrated) of the server, thereby providing an apparatus for recording an association between web pages of a web site and keywords used in a site specific keyword search.

Each web site 130 includes a number of web pages 131. Each web site also includes a site specific search facility 132. Upon receipt of a keyword search request by the site specific search facility 132 form a user in step 20, with the keyword search request being submitted from client computer 110-n and through network 105, the site specific search facility 132 responds to the client computer 110-n in step 22 by providing a site specific results listing containing hyperlinks to web pages 131 of the web site 130 associated with the keyword(s) in the search request.

In step 24 a selection of one of the web pages 131-m is received by means of the user selecting one of the hyperlinks presented in the site specific results listing. The selection of the web page 131-m from the site specific results listing validates the relevance of the web page 131-m with respect to the particular keyword(s) used in the search request. Accordingly, the keyword(s) received and the selected web page 131-n are recorded in step 26 for later evaluation.

Step 28 follows where a quality factor is calculated for each web page 131 of the web site 130 with respect to different keywords. In one embodiment a quality factor is based upon the sales rate per web page 131, being the number of searches completed on average before a sale is made.

In another embodiment the quality factor is based upon the click through rate, which is the ratio of the number of times a particular web page was selected and the number of times the web page appeared in site specific results listings.

In yet another other embodiments where sales are not necessarily targeted, the quality factor may be based upon a conversion rate. For example, a successful conversion may consist of a searching user registering with a web page or web site providing contact details. The conversion rate is the number of conversions made divided by the number of searches completed.

In yet another alternative embodiment proprietary or restricted data associated with products or services advertised by the web page may also be employed to assist the calculation of a quality factor. For example, access may be provided to a product database which has text descriptions, images, prices, category classes, manufacturer details and so forth relating to a particular product or service. Such background proprietary data may also be searched through for the keyword involved to provide an indication of any correlation between the keyword and a product or service on offer through the web site provided.

Those skilled in the art should appreciate that such quality factors may be calculated using a number of different variables. Sales margins, prices, availability assessments or even bid prices for particular keywords established using bid based search engines may all be employed, preferably divided in some way by the number of searches completed to provide a quality factor.

Furthermore, such basic calculation techniques as discussed above may also further be enhanced by a time dependent decay factor. Such a decay factor may reduce the relevance or impact of the quality boosting parameters if these parameters are sourced from old data or old events. In such instances the quality factor calculated may therefore be degraded over time unless new quality boosting events are recorded.

In step 30 of method 10 the quality factors, keywords and web page address for each web page 131 are supplied to an aggregation service 150 (FIG. 2) through the network 105.

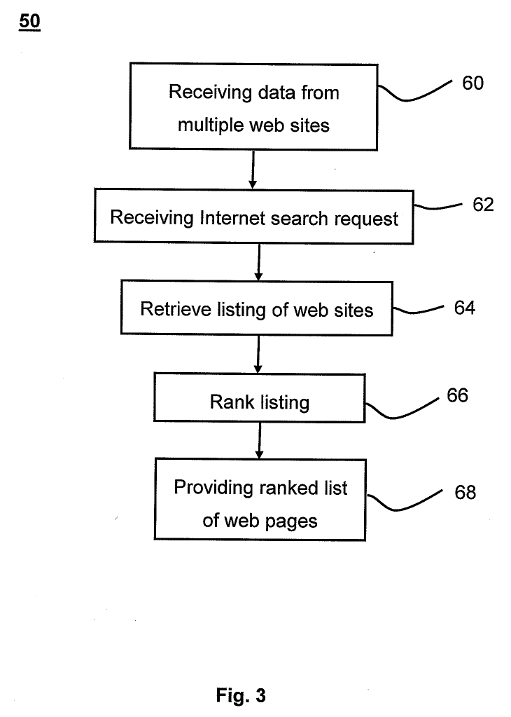

FIG. 3 shows a schematic flow diagram of a method 50 performed in the aggregation service 150 in order to provide an Internet search results list in response to an Internet keywords search request from client computer 110-n. The method 50 is implemented through software executing in the server (not illustrated) hosting the aggregation service 150. Again, the software may be stored on a computer readable medium. The software is read and executed in a processor (not illustrated) of the server, thereby providing an apparatus for performed in the aggregation service in order to provide an Internet search results list in response to an Internet keywords search request.

Method 50 starts in step 60 where data including quality factors, keywords and web page addresses for respective web pages 131 are received by the aggregate service 150. The data is stored in a database (not illustrated) associated with the server hosting the aggregate service 150.

Step 62 follows where an Internet keywords search request from client computer 110-n is received, with the request containing one or more keywords. In step 64 the aggregate service 150 retrieves from its database web pages associated with the keyword(s) in the Internet keywords search request, and rank in step 66 the web pages based upon their respective quality factors. In one implementation a ranked list of links to those web pages are provided to the client computer 110-n through the network 105.

In an alternative implementation additional results are added to the ranked list determined in step 66. The additional results are obtained from an Internet search engine (not illustrated) which obtain and ranks results of a keyword search in a manner known in the art. The additional results are combined with the ranked list determined in step 66. In one implementation the results are combined by merely supplementing the ranked list determined in step 66 with the additional results. In another implementation the results are interleaved. In yet another implementation a quality factor is determined for each listing of the additional results, and the combined list of results are ranked according to the respective quality factors.

The system 100 thus provides an Internet search results listing which comprises a ranked list of links to web pages. The relevance of each web page is confirmed through user activities associated with that web site.

Aspects of the present invention have been described by way of example only and it should be appreciated that modifications and additions may be made thereto without departing from the scope thereof.

We claim:

1. A method of providing an Internet search results list in response to an Internet keywords search request, said method comprising the steps of:
receiving a list of keywords, a list of web pages associated with the keywords in said list of keywords, and quality factors associated with keyword-web page combinations, said quality factors being determined from user activities in response to a site specific search request;
receiving said Internet keywords search request;
retrieving a listing of web pages associated with keywords in said Internet keywords search request;
ranking said web pages in said listing based upon associated quality factors to produce a ranked listing; and
providing said ranked listing in response to said Internet keywords search request.

2. A method as claimed in claim 1, further comprising the step of:
augmenting said ranked list with results from an external Internet search engine.

3. A method as claimed in claim 2, further comprising the step of:
determining a ranking for the results from the external Internet search engine with respect to the ranking of said ranked list.

4. A method of recording an association between web pages of a web site and keywords, said method comprising the steps of:
receiving a site specific keyword search request by a site specific search facility associated with said web site;
providing a listing of web pages of said web site;
receiving a selection of at least one web page from said listing of web pages;
determining a quality factor associated with keyword-web page combinations, said quality factors being determined from user activities with the associated web page following said following said site specific keyword search request and
recording said quality factors in association with respective keyword-web page combinations.

5. A method as claimed in claim 4 wherein said quality factors are based upon sales completed after said selection.

6. A method as claimed in claim 4 wherein said quality factors are based upon click through rates.

7. A method as claimed in claim 4 wherein said quality factors are based upon conversion rates.

8. A method as claimed in claim 7 wherein said conversion rates are based upon user registering with respective web pages.

9. A method as claimed in claim 4 wherein the determination of said quality factors includes a time factor.

10. Apparatus for providing an Internet search results list in response to an Internet keywords search request, said apparatus comprising:
means for receiving a list of keywords, a list of web pages associated with the keywords in said list of keywords, and quality factors associated with keyword-web page combinations, said quality factors being determined from user activities in response to a site specific search request;
means for receiving said Internet keywords search request;
means for retrieving a listing of web pages associated with keywords in said Internet keywords search request;
means for ranking said web pages in said listing based upon associated quality factors to produce a ranked listing; and
means for providing said ranked listing in response to said Internet keywords search request.

11. Apparatus for recording an association between web pages of a web site and keywords, said apparatus comprising:
means for receiving a site specific keyword search request by a site specific search facility associated with said web site;
means for providing a listing of web pages of said web site;
means for receiving a selection of at least one web page from said listing of web pages;
means for determining a quality factor associated with keyword-web page combinations, said quality factors being determined from user activities with the associated web page following said following said site specific keyword search request and
means for recording said quality factors in association with respective keyword-web page combinations.

12. A computer readable product having recorded thereon a program for implementing a method of providing an Internet search results list in response to an Internet keywords search request, said method comprising the steps of:
receiving a list of keywords, a list of web pages associated with the keywords in said list of keywords, and quality factors associated with keyword-web page combinations, said quality factors being determined from user activities in response to a site specific search request;
receiving said Internet keywords search request;
retrieving a listing of web pages associated with keywords in said Internet keywords search request;
ranking said web pages in said listing based upon associated quality factors to produce a ranked listing; and
providing said ranked listing in response to said Internet keywords search request.

13. A computer readable product having recorded thereon a program for implementing a method of recording an association between web pages of a web site and keywords, said method comprising the steps of:
receiving a site specific keyword search request by a site specific search facility associated with said web site;
providing a listing of web pages of said web site;
receiving a selection of at least one web page from said listing of web pages;
determining a quality factor associated with keyword-web page combinations, said quality factors being determined from user activities with the associated web page following said following said site specific keyword search request and
recording said quality factors in association with respective keyword-web page combinations.
